(19) United States
(12) Patent Application Publication
(10) Pub. No.: US 2003/0097552 A1
(43) Pub. Date: May 22, 2003

(54) Resilient boot prom loader

(76) Inventors: Robert E. Lewis, Highland, CA (US); Hien Q. Nguyen, Irvine, CA (US); Daryl G. Baxa, Trabuco Canyon, CA (US); David Stone, Irvine, CA (US); Parisa Salimi, Laguna Beach, CA (US)

Correspondence Address: LEFFERT JAY & POLGLAZE, P.A., P.O. BOX 581009, MINNEAPOLIS, MN, 55458-1009, US

(21) Appl. No.: 09/993,320

(22) Filed: Nov. 19, 2001

(51) Int. Cl. G06F 15/177

(52) U.S. Cl. 713/1

(57) ABSTRACT

A device apparatus and method is detailed that allows for improved operation and configuration of the communication device with a boot PROM selecting and loading from a management device. The improved communication device apparatus and method allows for the communication device to utilize a device ID and the routines stored on the boot PROM to connect to a management device and select and download the most appropriate operating software and/or firmware for the communication device model and revision. The improved device apparatus and method also allows for the selection and download of a diagnostic program for improved evaluation and testing of the communication device.

### TECHNICAL FIELD

The present invention relates generally to communication devices and in particular the present invention relates to boot programmable read only memories (PROM) loaders in communication devices.

### BACKGROUND

Modem networks and network systems are typically constructed of multiple differing devices, elements, or links, referred to collectively herein as elements. These elements include communication devices that connect networks and other elements across a link. Links can be virtual links that connect through other communication devices or physical links that connect across physical wire, cables, wireless, or optical connections. Links can be of multiple protocols and physical connections and signaling methods. Telecommunication devices are specialized communication devices that connect networks and elements across links that are part of a telecommunications or phone system. Examples of such include, but are not limited to, digital subscriber line (DSL), ethernet links, modems, token ring, network hubs, network switches, wide area network (WAN) bridges, integrated services digital network (ISDN) devices, T1 termination units, etc. In particular, one recent such communications link and protocol is the asymmetric digital subscriber line (ADSL).

Communication devices can have many physical configurations and implementations. Two popular physical configurations are the standalone enclosure and the line card chassis. Standalone enclosures are typically used at end user sites or link terminal sites where only one device is required. Line card chassis, also called a modular rack chassis, are popular in network hubs or telecommunication offices where multiple communication links end and the density and central management capability of a line card chassis is an advantage.

Many communication devices have a Flash or other non-volatile machine usable media containing firmware or software program routines that are utilized in device operation. The firmware is typically loaded by the communication device after power up or initialization into the main memory of a processing device that operates the communication device and is executed to begin function of the communication device in the network. Alternatively, in some communication devices, the processing device can execute the firmware in place from the non-volatile machine usable media.

This firmware is typically specific to the manufacturer, model, and/or revision of the communication device, requiring that the firmware be matched to the specific communication device hardware being used. This can be disadvantageous in the manufacturer's support and supply chain in that supplies of multiple revisions of a model of a communication device must be kept in stock and matched to the appropriate firmware when an exact replacement communication device is sent out or a new network system needs to be built. In this process the Flash or other non-volatile firmware storage media can be separated from the device. Additionally, marks or tags that identify the communication device model and revision can be accidentally removed causing a search for the appropriate model, revision, and firmware for the device. In some cases, the loss of the use of the specific device is possible.

The specific nature of the firmware has disadvantages in the management and update of communication devices that are in place in networks or network systems. In updating new revisions of firmware, which can happen often in a communication device as problems are fixed or standards updated, the administrator must match the model and revision of device to the appropriate firmware. Multiple firmware versions may need to be maintained and the inadvertent programming of the wrong firmware into a communication device is not unheard of, potentially causing the device to have to be sent back to the manufacturer for repair and loss of service.

Additionally, when diagnosing a potentially damaged, a newly manufactured, or a repaired communication device the communication device typically must have the Flash swapped out, or have the existing Flash device reprogrammed with a diagnostic program, usually with a specialized utility or reprogramming hardware. The diagnostic program can also be specific to the communication device model and/or revision. After the diagnostic program is run the communication device must then be reprogrammed with the appropriate version of the firmware. In all, this procedure is a labor intensive and complex process that is prone to error either at the manufacturer or in the field.

For the reasons stated above, and for other reasons stated below which will become apparent to those skilled in the art upon reading and understanding the present specification, there is a need in the art for a method and apparatus of conveniently identifying, programming, loading, and running firmware and diagnostics in communication devices in a network environment.

### SUMMARY

The above-mentioned problems with apparatus of conveniently identifying, programming, loading, and running firmware and diagnostics in communication devices in a network environment are addressed by embodiments of the present invention and will be understood by reading and studying the following specification.

In one embodiment, a method of operating a communication device with a boot PROM includes initializing the communication device from routines stored on the boot PROM, reading a device ID indicating a model and revision from the communication device, sending the device ID to a management device over a communications link, selecting a firmware at the management device, downloading the firmware to the communication device, and running the firmware on the communication device.

In another embodiment, a method of operating a communications management device includes initializing one or more associated communication devices from routines stored on a boot PROM of each of the one or more associated communication devices, receiving a device ID from each of one or more communication devices, selecting a software program associated with the device ID of each of the one or more communication devices, and downloading the software program associated with the device ID to each of the one or more communication devices.

In yet another embodiment, a method of operating a communications rack chassis with a management card and at least one communication card includes, initializing the at least one communication card from routines stored on a boot PROM of the communication card, receiving a device ID from each of the at least one communications card, selecting a firmware program associated with the device ID of each of the at least one communication card, and downloading the firmware program associated with the device ID to each of the at least one communication card.

In a further embodiment, a method of operating a communications system includes initializing one or more communication devices from routines stored on a boot PROM of each of the one or more communication devices, receiving a device iID from each of one or more communication devices at a management device, selecting a software program associated with the device ID of each of the one or more communication devices, and downloading the software program associated with the device ID to each of the one or more communication devices.

In yet a further embodiment, a method of operating an asymmetric digital subscriber line (ADSL) communication device with a boot PROM includes initializing the ADSL communication device from routines stored on the boot PROM, reading a device ID indicating a model and revision from the ADSL communication device, sending the device ID to a management device over a communications link, selecting a firmware for the communication device at the management device, downloading the firmware to the ADSL communication device, and running the firmware on the ADSL communication device.

In another embodiment, a communication device includes a boot PROM, a communications interface, a device ID storage media, and a processor coupled to the boot PROM, the device ID storage media, and the communications interface, where the processor utilizes a device ID read from the device ID storage media and routines from the boot PROM to select and download a firmware program for the device through the communications interface.

In yet another embodiment, an asymmetric digital subscriber line (ADSL) communication device includes a boot PROM, a communications interface, a device ID storage media, and a processor coupled to the boot PROM, the device ID storage media, and the communications interface, where the processor utilizes a device ID read from the device ID storage media and routines from the boot PROM to select and download a firmware program for the device through the communications interface.

In a further embodiment, a communications rack chassis includes a management card, and at least one communications card. The at least one communications card including a boot PROM, a device ID storage media, and a processor coupled to the boot PROM and the device ID storage media, where the processor utilizes a device ID read from the device ID storage media and routines from the boot PROM to communicate with the management card and select and download a firmware program for the card.

In yet a further embodiment, a network system includes a management device, and at least one communication device. The at least one communication device includes a boot PROM, a device ID storage media, and a processor coupled to the boot PROM and the device ID storage media, where the processor utilizes a device ID read from the device ID storage media and routines from the boot PROM to communicate with the management device and select and download a firmware program for the device.

In another embodiment, a machine-usable medium has machine-readable instructions stored thereon for execution by a processor of a telecommunication device to perform a method. The method includes initializing the telecommunication device from routines stored on a boot PROM of the telecommunications device, reading a device ID indicating a model and revision from the telecommunication device, sending the device ID to a management device over a communications link, selecting a firmware for the telecommunications device at the management device, downloading the selected firmware to the telecommunication device, and running the firmware on the telecommunication device.

In yet another embodiment, a machine-usable medium has machine-readable instructions stored thereon for execution by a processor of a telecommunications management device to perform a method. The method includes initializing one or more associated telecommunication devices from routines stored on a boot PROM, receiving a device ID from each of one or more telecommunication devices, selecting a software program associated with the device ID of each of one or more telecommunication devices, and downloading the software program associated with the device ID to each of one or more telecommunication devices.

In a further embodiment, a telecommunication device has a boot PROM, a communications interface, a device ID storage media, and a processor coupled to the boot PROM, the device ID storage media, and the communications interface, and a method of operating the telecommunication device. The method of operating the telecommunication device includes initializing the telecommunication device from routines stored on the boot PROM, reading a device ID indicating a model and revision from the telecommunication device, sending the device ID to a management device over a communications link, selecting a firmware at the management device, downloading the firmware to the telecommunication device, and running the firmware on the telecommunication device.

Other embodiments are described and claimed.

### BRIEF DESCRIPTION OF THE DRAWINGS

FIG. 1 is a simplified diagram of a communication device according to one embodiment of the present invention.

FIGS. 2A and 2B are simplified diagrams of embodiments of the present invention.

### DETAILED DESCRIPTION

In the following detailed description, reference is made to the accompanying drawings that form a part hereof, and in which is shown by way of illustration specific embodiments in which the inventions may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense, and the scope of the present invention is defined only by the claims.

As stated above, selecting the firmware appropriate for the communications device model and/or revision being reprogrammed, as well as loading and programming the firmware into the communication device, are involved tasks for manufacturers and system administrators. This is particularly the case for diagnostics where the administrator must program and run a diagnostics routine that is specific for a model and revision of a communication device and then reprogram the appropriate operational firmware when finished testing. Embodiments of the present invention utilize software routines that enable the communication device to initialize and initiate contact with a management device. The management device then determines the appropriate software routines or firmware to download to the requesting communication device based on the identification of the device.

In one embodiment of the present invention this is done with a device ID that was sent by the requesting communication device, and that uniquely identifies the communication device and its model/revision. The communication device receives the selected firmware from the management device, loads it into its main memory, and transfers operative control of the device to the routines contained in the firmware downloaded from the management device. The method embodiments of the present invention simplify communication device design by eliminating the need for a non-volatile firmware storage media, such as a Flash memory, on the communication device. Communication device management is simplified also by eliminating the need to individually identify the model and revision and update the firmware of each communications device in a network system with the appropriate version of firmware, only a central management device needs to be maintained with updated firmware. Each communication device is also easily identified by a device ID that is incorporated into the device.

The communication device software routines that initiate communication with the management device and download the required firmware for the device are collectively referred to as a “boot PROM” after the programmable read only memory (PROM) machine usable non-volatile storage device that such routines have historically been stored in. It is noted that such boot PROM routines can be stored on a variety of machine usable storage mediums that include, but are not limited to, a non-volatile Flash memory, a read only memory (ROM), a electrically erasable programmable read only memory (EEPROM), a one time programmable (OTP) device, a complex programmable logic device (CPLD), an application specific integrated circuit (ASIC), a magnetic media disk, etc.

In the control of the initialization, configuration, and operation of communication devices embodiments of the present invention, the boot PROM routines or firmware can be contained a storage element or storage medium that is a computer-readable or machine-usable media. Computer-readable or machine-usable media is defined for the purposes of this disclosure as a set of computer-readable instructions stored on a computer-usable medium for execution by a processor. Examples of computer-usable media include, but are not limited to, removable and non-removable magnetic media, optical media, dynamic random-access memory (DRAM), static random-access memory (SRAM), read-only memory (ROM) and electrically-erasable and programmable read-only memory (EEPROM or Flash). It is also noted that communication devices can take multiple other physical forms, including, but not limited to, communication devices that are functions of other network elements, or network elements that have the communication device functionality expressed in firmware or even hard-coded in a device such as an application-specific integrated circuit (ASIC) chip.

Boot PROM technology has been known in the past as an enabling technology for “diskless” workstations and access terminals or workstations that are integrated into a highly centralized network control and security environment. For communication devices, however, boot PROM utilization has several distinct advantages. The boot PROM code generally is small in relative size to the firmware and generally does not change much over the expected device life allowing for smaller non-volatile storage needs on the communication device and fewer updates. All the boot PROM generally must do is initialize the system, communicate with the management device, and enable loading of device firmware into the communication device main memory. The software routines stored in the boot PROM generally consist of initialization routines for the communication device, basic communication protocol routines to allow communication with a management device, routines that identify the device and any required configuration information, routines that allow for the download of firmware, and routines that allow the loading of the firmware into device memory and transfer of control to the loaded firmware routines, and the like. It is noted that the boot PROM may also include routines and/or information that is reusable by the firmware routines downloaded to communication device.

The use of a boot PROM device allows for ease of communications device management and update in that only a central management device must be updated when new firmware for a communication device is available, eliminating the need for reprogramming and time required to reprogram multiple communication devices in an operating system. This update of a central management device is in various embodiments performed without specialized hardware or remotely across a network.

When the communication devices communicate to a management device a device ID that uniquely identifies the appropriate firmware is sent and the firmware is selected by the management device for downloading into the device without time consuming and error prone matching of the appropriate firmware to the communications device by an administrator. If the communications device has a conventional internal firmware storage medium attached to it, such as a Flash memory, the boot PROM utilized to automatically keep the firmware on the storage media up to date by simply programming it with the downloaded firmware. This utilization of internal firmware storage media on the configuration device speeds initialization and configuration of the communication device in certain cases. In these situations the version of the firmware stored on the communication device is communicated to the management device. The management device then skips the download of the selected firmware, if it is of the same version as the firmware that is programmed on the communication device and instructs the communication device to use its locally saved firmware. Alternatively, a completely different firmware is selected by the management device for the communication device to download and run, but not to save, into a local storage media. One such case of this is the utilization of a diagnostic software routine or a special purpose firmware.

Boot PROM utilization in communication devices also has several distinct advantages for manufacturers in supply chain characteristics and ability to run diagnostics. The boot PROM of the communications device which automatically loads the correct version of the firmware from a management device allows the manufacturer to treat differing revisions of the same model of communications device as if they were identical components in the supply and parts replacement distribution chain. The manufacturer can rely on the boot PROM mechanism to ensure the correct firmware is loaded into the correct models and revisions.

The boot PROM embodiments of the present invention also have advantages in diagnostics, manufacture and field testing. In one embodiment, at the manufacturer's factory or repair site a specialized test facility or modular rack chassis is set up which in an automated manner loads diagnostic firmware into the coupled communications devices instead of the standard firmware and runs tests to determine faults. After testing no reprogramming of the communications device or replacement of firmware storage media is required. Such a testing station reduces overhead and errors in the testing process and is also in some embodiments utilized to diagnose returned, repaired, or new communication devices.

To facilitate matching of the firmware to a communication device model and/or revision, one embodiment of the present invention stores a device ID in the communications device. The device ID is sent to the management device along with any other optional communication device configuration information that is useful and the management device uses the information in selecting the correct firmware for the requesting communication device. In another embodiment, the device ID uniquely identifies the card model and/or revision of the communications device. It is noted that the device ID is any information, including configuration information that allows the management device to identify the appropriate firmware version for the communication device. The device ID is such information about the communication device that allows the management device to unambiguously select the firmware for the communication device. The device ID can include, and is not limited to, information such as the manufacturers unique identification number for the communication device, revision information of that communication device, component, configuration, and memory map information about that communication device.

The device ID can be encoded in the communications device in one or more of many non-volatile storage elements, including, but not limited to, encoding in a Flash memory, a programmable logic device, a CPLD, in a ROM, a EEPROM, pull up resistors, etc. In one embodiment the device ID is permanently associated with the communications device to avoid potential loss. An example of such a device ID that is permanently associated with the communications device is a device ID encoded in a soldered on ROM, or a OTP device.

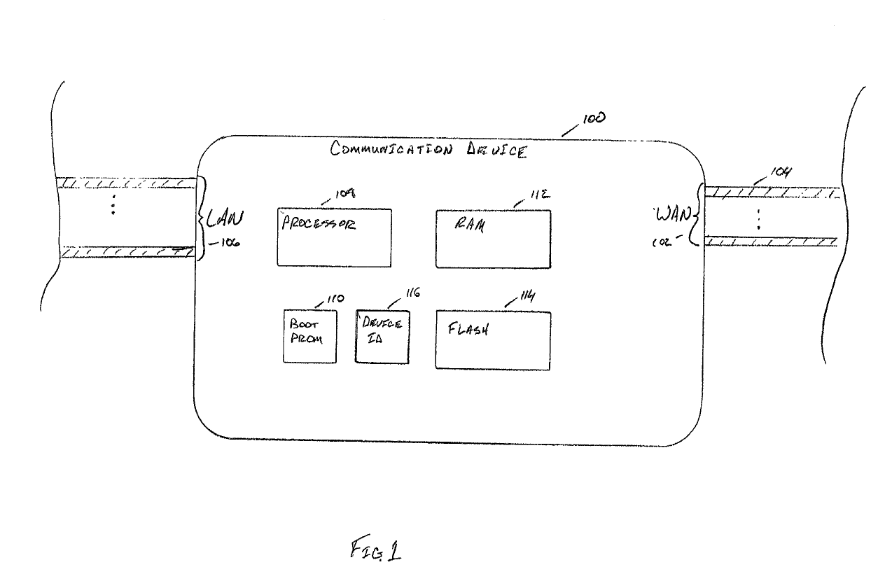

FIG. 1 details a simplified block diagram of a communication device 100 with one or more wide area network (WAN) dataports 102 coupled to one or more communication links 104. The communication device 100 also has one or more local area networks (LAN) dataports 106. The communication device internally contains a processor 108, a boot PROM 110, a random access memory (RAM) 112, a device ID storage 116, and an optional non-volatile machine usable firmware storage media 114, such as a Flash memory. It is noted that the LAN dataports 106 can also include communication busses and/or other proprietary communication interface or protocol. An example of one such proprietary communications bus is the “Cellbus” communications chassis backplane bus of ADC Telecommunications, Inc. Eden Prairie, Minn.

In operation of the communication device 100 of FIG. 1, the processor 108 initializes the communication device 100 on power up or reset and reads the boot PROM 110, and executes the contained routines. The communication device 100 then under direction of the processor 108 communicates through one of the external interfaces 106, 102, with the management device (not shown). The processor 108 of the communication device 100 reads its device ID from the device ID storage 116 and communicates it and any additional information, such as configuration parameters or saved firmware version, to the management device. The management device selects the appropriate firmware for the communication device 100 and downloads it to the communication device 100 through one of the external interfaces 102, 106. The processor 108 of the communication device 100 loads the received firmware into RAM 112, configures itself, and begins operation by processing the firmware placed in the RAM 112.

If the communication device 100 has an optional non-volatile firmware storage media 114, such as a Flash memory (if so equipped) which contains previously saved firmware, the management device can opt to skip the download of the selected firmware, if it is the same version as the firmware in the non-volatile firmware storage media 114, and simply instruct the communication device 100 to use the locally saved firmware in the non-volatile firmware storage media 114 by either loading it into the RAM 112 or executing it in place from the firmware storage media 114. Alternatively, the management device can download firmware to the communications device 100 and instruct the processor 108 of the communication device 100 to store the received firmware into the non-volatile firmware storage media 114, in addition to or alternatively to the RAM 112, if the storage media is electrically programmable, such as a Flash memory device. It is noted that the boot PROM 110, and the device ID storage 116 need not be separate devices and that other embodiments combine the devices into a single storage device or, alternatively, eliminate the devices and store the boot PROM routines and device ID into the firmware storage media 114. For example, the device ID information is programmed to a nonvolatile Flash or EEPROM after manufacture in one embodiment.

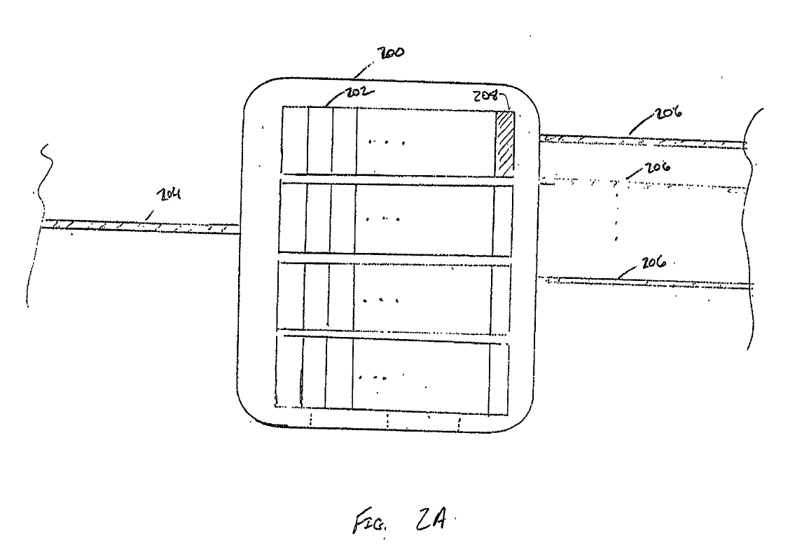

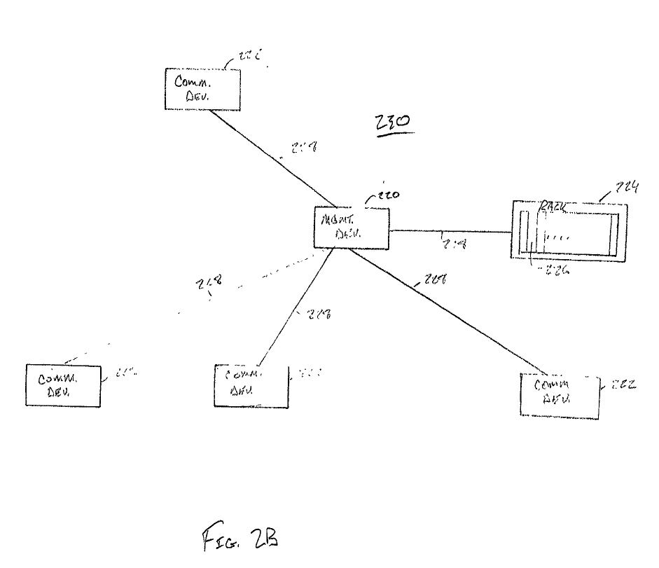

FIG. 2A is a simplified diagram of a modular rack chassis 200 embodiment of the present invention. The modular rack chassis 200 contains line card communication devices 202 managed by a line card management device 208. The modular rack chassis 200 is coupled to one or more upstream networks 204, and one or more downstream networks 206. Other network connections and arrangements of the modular rack chassis are possible. It is noted that the line card management device 208 of embodiments of the present invention can manage other systems in addition to the detailed modular rack chassis 200.

In operation of the modular rack chassis 200 of FIG. 2A, the processor (not shown) of each line card communication device 202, such as communications device 100 described above, initializes the line card communication device 202 reads a boot PROM on each line card communication device, and executes the contained routines. Each line card communication device 202 then communicates with the line card management device 208 and communicates its device ID and any additional information, such as configuration parameters or saved firmware version, to the management device. The management device 208 selects the appropriate firmware for the communication device 202 and downloads it to the communication device 202. The communication device 202 loads the received firmware, configures itself, and begins operation. If the communication device 202 has an onboard firmware storage media (if so equipped) which contains saved firmware the management device 208 can opt to skip the download of the selected firmware, if it is the same version as the firmware that is programmed on the communication device 202, and simply instruct the communication device 202 to use its locally saved firmware by either loading it into the communication device RAM or executing it in place from the firmware storage media.

An ADSL communication device is one type of communication device that is utilized in a modular rack chassis embodiment of the present invention. One embodiment of an ADSL modem line card communications device 202 is the Avidia system made by ADC Telecommunications, Inc. Eden Prairie, Minn. The Avidia ADSL modem line card contains several LAN dataports that include a Cellbus chassis communication bus and an E1 or T1 dataport. The Avidia ADSL modem line card also includes an ADSL WAN dataport that is coupled to one of the downstream networks 206.

FIG. 2B is a simplified diagram of a network system 230 embodiment of the present invention. The network system 230 contains a management device 220 and one or more communication devices 222 that each have boot PROMs as described above. The network system 230 also contains an optional modular rack system 224 that contains one or more line card communication devices 226 that have boot PROMs. The communication devices 222 and the line card communication devices 226 of the modular rack chassis 200 are coupled to one or more upstream networks (not shown), and one or more downstream networks (not shown). The communication devices 222 and the line card communication devices 226 of the modular rack chassis 200 are coupled by a communications network 228 to the management device 220. It is noted that other network connections and arrangements of the network system 230 are possible.

In operation of the network system 230 of FIG. 2B, the processor (not shown) of each communication device 222, 226 initializes the communication device 222, 226, reads the communication device boot PROM, and executes the contained routines. Each communication device 222, 226 then contacts the management device 220 over the communications network 228 and communicates its device ID and any additional information, such as configuration parameters or saved firmware version. The management device 220 selects the appropriate firmware for the communication device 222, 226 and downloads it over the communications network 228 to the communication device 222, 226. The communication device 222, 226 loads the received firmware, configures itself, and begins operation. If the communication device 222, 226 has a saved firmware (if so equipped) the management device 220 can opt to skip the download of the selected firmware, if it is of the same version as the firmware that is programmed on the communication device 222, 226, and simply instruct the communication device 222, 226 to use its locally saved firmware.

Alternative communication device embodiments of the present invention with an ability to load firmware from a management device using a boot PROM will be apparent to those skilled in the art with the benefit of the present disclosure, and are also within the scope of the present invention.

### Conclusion

A device apparatus and method are described that allows for improved operation and configuration of the communication device with a boot PROM selecting and loading from a management device. The improved communication device apparatus and method allows for the communication device to utilize a device ID and the routines stored on the boot PROM to connect to a management device and select and download the most appropriate operating software and/or firmware for the communication device model and revision. The improved device apparatus and method also allows for the selection and download of a diagnostic program for improved evaluation and testing of the communication device.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. A method of operating a communication device with a boot PROM, comprising:
initializing the communication device from routines stored on the boot PROM;
reading a device ID indicating a model and revision from the communication device;
sending the device ID to a management device over a communications link; selecting a firmware at the management device;
downloading the firmware to the communication device; and
running the firmware on the communication device.

2. The method of claim 1, further comprising:
storing the downloaded firmware into a RAM memory.

3. The method of claim 1, further comprising:
storing the downloaded firmware into a non-volatile machine usable storage media.

4. The method of claim 3, wherein the non-volatile machine usable storage media is selected from the group consisting of a Flash memory device, an electrically erasable programmable read only memory (EEPROM) device, and a one time programmable (OTP) device.

5. The method of claim 3, wherein the boot PROM routines are stored on the nonvolatile machine usable storage media.

6. The method of claim 3, wherein the boot PROM routines and device ID are stored on the non-volatile machine usable storage media.

7. The method of claim 1, further comprising:
sending a version identifier of a stored firmware from a non-volatile machine usable storage media to the management device.

8. The method of claim 1, wherein the device ID is read from a machine readable storage device.

9. The method of claim 8, wherein the device ID storage device is selected from the group consisting of a Flash memory device, a read only memory (ROM), an electrically erasable programmable read only memory (EEPROM) device, and a one time programmable (OTP) device.

10. The method of claim 1, wherein the boot PROM is selected from the group consisting of a Flash memory device, a read only memory (ROM), an electrically erasable programmable read only memory (EEPROM) device, and a one time programmable (OTP) device.

11. The method of claim 1, wherein the boot PROM and device ID are stored on a single machine readable storage medium.

12. The method of claim 1, wherein downloading firmware comprises downloading diagnostic firmware.

13. A method of operating a communications management device, comprising:
initializing one or more associated communication devices from routines stored on a boot PROM of each of the one or more associated communication devices;
receiving a device ID from each of one or more communication devices;
selecting a software program associated with the device ID of each of the one or more communication devices; and
downloading the software program associated with the device ID to each of the one or more communication devices.

14. The method of claim 13, wherein receiving a device ID from each of one or more communication devices further comprises receiving a device ID that uniquely identifies the communication device.

15. The method of claim 13, wherein receiving a device ID from each of one or more communication devices further comprises receiving a device ID that identifies the communication device model.

16. The method of claim 13, wherein receiving a device ID from each of one or more communication devices further comprises receiving a device ID that identifies the communication device model and revision.

17. The method of claim 13, wherein receiving a device ID from each of one or more communication devices further comprises receiving a device ID that uniquely identifies the software program for the communication device.

18. The method of claim 13, wherein receiving a device ID from each of one or more communication devices further comprises receiving a device ID that uniquely identifies one or more software programs for the communication device.

19. The method of claim 13, further comprising:
updating a store of firmware at the communications management device.

20. A method of operating a communications rack chassis with a management card and at least one communication card, comprising:
initializing the at least one communication card from routines stored on a boot PROM of the communication card;
receiving a device ID from each of the at least one communications card;
selecting a firmware program associated with the device ID of each of the at least one communication card; and
downloading the firmware program associated with the device ID to each of the at least one communication card.

21. The method of claim 20, further comprising:
storing the downloaded firmware into a RAM memory of each of the at least one communication card.

22. The method of claim 20, further comprising:
storing the downloaded firmware into a non-volatile machine usable storage media of each of the at least one communication card.

23. The method of claim 20, further comprising:
sending a version identifier of a stored firmware from a non-volatile machine usable storage media of each of the at least one communication card to the management card.

24. The method of claim 20, wherein the boot PROM and device ID are stored on a single machine readable storage medium of each of the at least one communication card.

25. The method of claim 20, further comprising:
updating a repository of firmware stored on the management card.

26. The method of claim 25, wherein the repository of firmware is updated remotely across a communication link.

27. A method of operating a communications system, comprising:
initializing one or more communication devices from routines stored on a boot PROM of each of the one or more communication devices;
receiving a device ID from each of one or more communication devices at a management device;
selecting a software program associated with the device ID of each of the one or more communication devices; and
downloading the software program associated with the device ID to each of the one or more communication devices.

28. The method of claim 27, further comprising:
storing the downloaded software program into a RAM memory of each of the one or more communication devices.

29. The method of claim 27, further comprising:
storing the downloaded software program into a non-volatile machine usable storage media of each of the one or more communication devices.

30. The method of claim 27, further comprising:
sending a version identifier of a stored software program from a non-volatile machine usable storage media of each of the one or more communication devices to the management device.

31. The method of claim 27, wherein the boot PROM and device ID are stored on a single machine readable storage medium of each of the one or more communication devices.

32. The method of claim 27, further comprising:
updating a repository of software program stored on the management device.

33. The method of claim 32, wherein the repository of software program is updated remotely across a communication link of the communications system.

34. A method of operating an asymmetric digital subscriber line (ADSL) communication device with a boot PROM, comprising:
initializing the ADSL communication device from routines stored on the boot PROM;
reading a device ID indicating a model and revision from the ADSL communication device;
sending the device ID to a management device over a communications link;
selecting a firmware for the communication device at the management device;
downloading the firmware to the ADSL communication device; and
running the firmware on the ADSL communication device.

35. The method of claim 34, further comprising:
storing the downloaded firmware into a RAM memory of the ADSL communication device.

36. The method of claim 34, further comprising:
storing the downloaded firmware into a non-volatile machine usable storage media of the ADSL communication device.

37. The method of claim 34, further comprising:
sending a version identifier of a stored firmware from a non-volatile machine usable storage media of the ADSL communication device to the management device.

38. The method of claim 34, wherein the boot PROM and device ID are stored on a single machine readable storage medium of the ADSL communication device.

39. The method of claim 34, wherein the device ID identifies a model and a revision of the ADSL communication device.

40. The method of claim 34, wherein sending the device ID to a management device over a communications link further comprises sending the device ID and configuration information.

41. A communication device, comprising:
a boot PROM;
a communications interface;
a device ID storage media; and
a processor coupled to the boot PROM, the device ID storage media, and the communications interface, where the processor utilizes a device ID read from the device ID storage media and routines from the boot PROM to select and download a firmware program for the device through the communications interface.

42. The communication device of claim 41, further comprising:
a RAM memory coupled to the processor, where the processor stores the downloaded firmware into the RAM memory.

43. The communication device of claim 41, further comprising:
a non-volatile machine usable storage media coupled to the processor, where the processor stores the downloaded firmware into the storing the downloaded firmware the non-volatile machine usable storage media.

44. The communication device of claim 43, wherein the non-volatile machine usable storage media is selected from the group consisting of a Flash memory device, an electrically erasable programmable read only memory (EEPROM) device, and a one time programmable (OTP) device.

45. The communication device of claim 41, wherein the device ID storage device is permanently attached to the communication device.

46. The communication device of claim 41, wherein the device ID storage device is selected from the group consisting of a Flash memory device, a read only memory (ROM), an electrically erasable programmable read only memory (EEPROM) device, and a one time programmable (OTP) device.

47. The communication device of claim 41, wherein the boot PROM is permanently attached to the communication device.

48. The communication device of claim 41, wherein the boot PROM is selected from the group consisting of a Flash memory device, a read only memory (ROM), an electrically erasable programmable read only memory (EEPROM) device, and a one time programmable (OTP) device.

49. The communication device of claim 41, wherein the boot PROM and device ID are stored on a single machine readable storage medium.

50. The communication device of claim 41, wherein the downloaded firmware is a diagnostic firmware.

51. An asymmetric digital subscriber line (ADSL) communication device, comprising:
a boot PROM;
a communications interface;
a device ID storage media; and
a processor coupled to the boot PROM, the device ID storage media, and the communications interface, where the processor utilizes a device ID read from the device ID storage media and routines from the boot PROM to select and download a firmware program for the device through the communications interface.

52. The asymmetric digital subscriber line (ADSL) communication device of claim 51, further comprising:
a RAM memory coupled to the processor, where the processor stores the downloaded firmware into the RAM memory.

53. The asymmetric digital subscriber line (ADSL) communication device of claim 51, further comprising:
a non-volatile machine usable storage media coupled to the processor, where the processor stores the downloaded firmware into the storing the downloaded firmware the non-volatile machine usable storage media.

54. The asymmetric digital subscriber line (ADSL) communication device of claim 51, wherein the device ID storage device is permanently attached to the communication device.

55. The asymmetric digital subscriber line (ADSL) communication device of claim 51, wherein the boot PROM is permanently attached to the communication device.

56. The asymmetric digital subscriber line (ADSL) communication device of claim 51, wherein the downloaded firmware is a diagnostic firmware.

57. A communications rack chassis, comprising:
a management card; and
at least one communications card, the at least one communications card comprising,
a boot PROM;
a device ID storage media; and
a processor coupled to the boot PROM and the device ID storage media, where the processor utilizes a device ID read from the device ID storage media and routines from the boot PROM to communicate with the management card and select and download a firmware program for the card.

58. The communications rack chassis of claim 57, wherein the at least one communications card further comprises:
a RAM memory coupled to the processor, where the processor stores the downloaded firmware into the RAM memory.

59. The communications rack chassis of claim 57, wherein the at least one communications card further comprises:
a non-volatile machine usable storage media coupled to the processor, where the processor stores the downloaded firmware into the storing the downloaded firmware the non-volatile machine usable storage media.

60. The communications rack chassis of claim 57, wherein the boot PROM and device ID are stored on a single machine readable storage medium of each of the at least one communication card.

61. The communications rack chassis of claim 57, wherein the downloaded firmware is a diagnostic firmware.

62. The communications rack chassis of claim 57, wherein the communications rack chassis is a diagnostics rack chassis and the downloaded firmware is a diagnostic firmware.

63. A network system, comprising:
a management device; and
at least one communication device, the at least one communication device comprising,
a boot PROM;
a device ID storage media; and
a processor coupled to the boot PROM and the device ID storage media, where the processor utilizes a device ID read from the device ID storage media and routines from the boot PROM to communicate with the management device and select and download a firmware program for the device.

64. The network system of claim 63, wherein the at least one communications device further comprises:
a RAM memory coupled to the processor, where the processor stores the downloaded firmware into the RAM memory.

65. The network system of claim 63, wherein the at least one communications device further comprises:
a non-volatile machine usable storage media coupled to the processor, where the processor stores the downloaded firmware into the storing the downloaded firmware the non-volatile machine usable storage media.

66. The network system of claim 63, wherein the boot PROM and device ID are stored on a single machine readable storage medium of each of the at least one communication device.

67. The network system of claim 63, wherein the downloaded firmware is a diagnostic firmware.

68. The network system of claim 63, wherein the network system is a diagnostics rack chassis and the downloaded firmware is a diagnostic firmware.

69. A machine-usable medium having machine-readable instructions stored thereon for execution by a processor of a telecommunication device to perform a method comprising:
initializing the telecommunication device from routines stored on a boot PROM of the telecommunications device;
reading a device ID indicating a model and revision from the telecommunication device;
sending the device ID to a management device over a communications link;
selecting a firmware for the telecommunications device at the management device;
downloading the selected firmware to the telecommunication device; and
running the firmware on the telecommunication device.

70. The machine-usable medium of claim 69, further comprising:
storing the downloaded firmware into a RAM memory.

71. The machine-usable medium of claim 69, further comprising:
storing the downloaded firmware into a non-volatile machine usable storage media.

72. The machine-usable medium of claim 71, wherein the non-volatile machine usable storage media is selected from the group consisting of a Flash memory device, an electrically erasable programmable read only memory (EEPROM) device, and a one time programmable (OTP) device.

73. The machine-usable medium of claim 71, wherein the boot PROM routines are stored on the non-volatile machine usable storage media.

74. The machine-usable medium of claim 71, wherein the boot PROM routines and device ID are stored on the non-volatile machine usable storage media.

75. A machine-usable medium having machine-readable instructions stored thereon for execution by a processor of a telecommunications management device to perform a method comprising:
initializing one or more associated telecommunication devices from routines stored on a boot PROM;
receiving a device ID from each of one or more telecommunication devices;
selecting a software program associated with the device ID of each of one or more telecommunication devices; and
downloading the software program associated with the device ID to each of one or more telecommunication devices.

76. The machine-usable medium of claim 75, wherein the downloaded firmware is a diagnostic firmware.

77. The machine-usable medium of claim 75, further comprising:
updating a repository of firmware stored on the telecommunication management device.

78. The machine-usable medium of claim 77, wherein the repository of firmware is updated remotely across a communication link.

79. The machine-usable medium of claim 75, further comprising:
storing the downloaded firmware into a RAM memory of each of the one or more telecommunication devices.

80. The machine-usable medium of claim 75, further comprising:
storing the downloaded firmware into a non-volatile machine usable storage media of each of the one or more telecommunication devices.

81. In a telecommunication device having a boot PROM, a communications interface, a device ID storage media, and a processor coupled to the boot PROM, the device ID storage media, and the communications interface, a method of operating the telecommunication device, comprising:
initializing the telecommunication device from routines stored on the boot PROM;
reading a device ID indicating a model and revision from the telecommunication device;
sending the device ID to a management device over a communications link;
selecting a firmware at the management device;
downloading the firmware to the telecommunication device; and
running the firmware on the telecommunication device.
